(19) United States
(12) Patent Application Publication
(10) Pub. No.: US 2007/0273350 A1
(43) Pub. Date: Nov. 29, 2007

(54) Pwm Drive Circuit

(76) Inventor: Seiichi Yamamoto, Kyoto (JP)

Correspondence Address: FISH & RICHARDSON P.C., P.O. BOX 1022, MINNEAPOLIS, MN, 55440-1022, US

(21) Appl. No.: 10/599,845

(22) PCT Filed: Mar. 29, 2005
(86) PCT No.: PCT/JP05/05825

§ 371 Date: Oct. 11, 2006

(30) Foreign Application Priority Data
May 11, 2004 (JP) 2004-140568

(51) Int. Cl. G05F 1/00

(52) U.S. Cl. 323/284

(57) ABSTRACT

A PWM drive circuit of the present invention is built with a load driving power MOS transistor Q5 (Q6), a resistor R3 (R5) or R4 (R6), and a capacitance of the MOS transistor Q5 (Q6). The PWM drive circuit is provided with: a CR circuit that reduces a through rate of a voltage based on a PWM voltage and then feeds the resultant voltage to the gate of the MOS transistor Q5 (Q6); and a gate voltage control portion 4 (5) that stops an operation of the CR circuit and pulls down (up) the gate potential of the MOS transistor Q5 (Q6) to a predetermined value upon detecting during a transition period of a gate voltage of the MOS transistor Q5 (Q6) that the MOS transistor Q5 (Q6) is completely switched from off to on. This makes it possible to reduce switching noise and switching loss.

### TECHNICAL FIELD

The present invention relates to a PWM drive circuit, and more particularly to a PWM drive circuit that can reduce switching noise.

### BACKGROUND ART

In PWM drive circuits, through rate control is generally performed to reduce switching noise (for example, see [0007] of Patent Document 1). Through rate control is performed aimed at reducing switching noise by making a gate voltage of a power MOS transistor for driving a load (hereinafter a “load driving power MOS transistor”) rise or drop gradually.

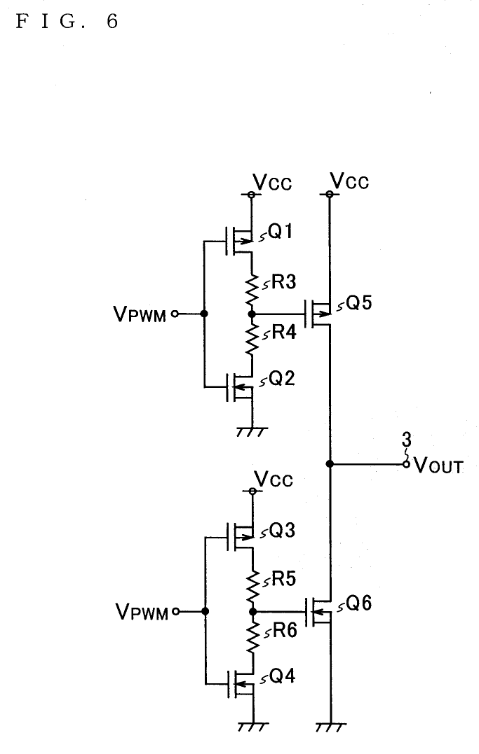

Here, an example of the configuration of a conventional PWM drive circuit in which through rate control is performed is shown in FIG. 5. The PWM drive circuit shown in FIG. 5 includes P-channel MOS transistors (hereinafter “PMOS transistors”) Q1, Q3, and Q5, N-channel MOS transistors (hereinafter “NMOS transistors”) Q2, Q4, and Q6, resistors R1 and R2, and an output terminal 3.

The PMOS transistor Q1 and the NMOS transistor Q2 together form an inverter circuit 1, and an output end thereof is connected to the gate of the PMOS transistor Q5 via the resistor R1. The PMOS transistor Q3 and the NMOS transistor Q4 together form an inverter circuit 2, and an output end thereof is connected to the gate of the NMOS transistor Q6 via the resistor R2. A constant voltage V_{CC} is applied to the source of the PMOS transistor Q5, and the source of the NMOS transistor Q6 is grounded. The drain of the PMOS transistor Q5 and the drain of the NMOS transistor Q6 are connected to the output terminal 3.

The inverter circuit 1 inverts a PWM voltage V_{PWM} inputted thereto and outputs the resultant voltage. Since the output of the inverter circuit 1 is fed to the gate of the PMOS transistor Q5 by way of a CR circuit built with the resistor R1 and a capacitance of the PMOS transistor Q5 (such as a gate-source capacitance or a gate-backgate capacitance), a gate voltage of the PMOS transistor Q5 rises or drops gradually.

The inverter circuit 2 inverts a PWM voltage V_{PWM} inputted thereto and outputs the resultant voltage. Since the output of the inverter circuit 2 is fed to the gate of the NMOS transistor Q6 by way of a CR circuit built with the resistor R2 and a capacitance of the NMOS transistor Q6 (such as a gate-source capacitance or a gate-backgate capacitance), a gate voltage of the NMOS transistor Q6 rises or drops gradually.

As described above, since the gate voltages of the PMOS transistor Q5 and the NMOS transistor Q6, which are load driving power MOS transistors, rise or drop gradually, it is possible to reduce switching noise.

Additionally, in the PWM drive circuit shown in FIG. 5, when the PWM voltage V_{PWM} is at a High level, the PMOS transistor Q5 is turned on and the NMOS transistor Q6 is turned off, whereby a value of the output voltage V_{OUT} outputted from the output terminal 3 becomes approximately equal to V_{CC}; when the PWM voltage V_{PWM} is at a Low level, the PMOS transistor Q5 is turned off and the NMOS transistor Q6 is turned on, whereby a value of the output voltage V_{OUT} outputted from the output terminal 3 becomes approximately equal to zero.

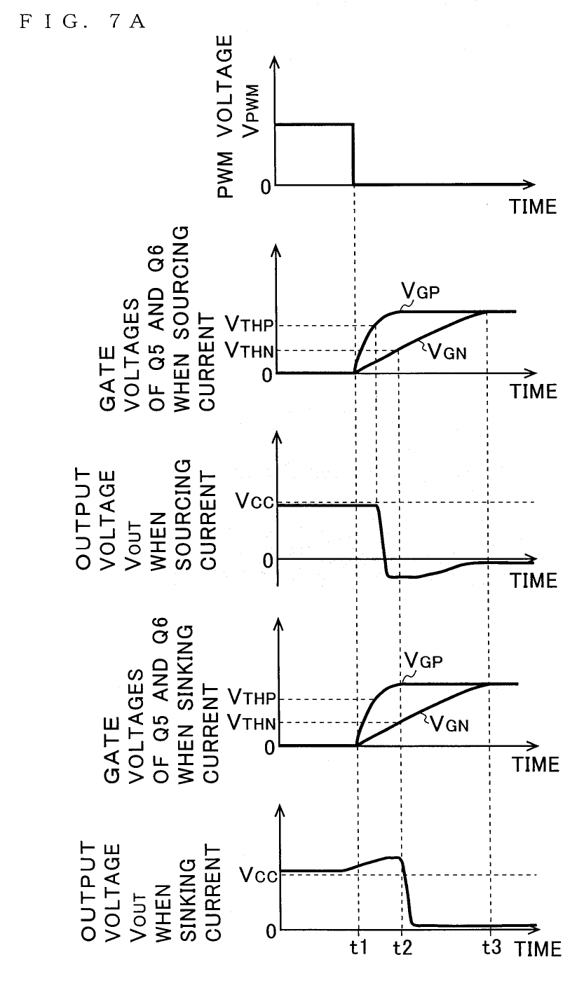

Another example of the configuration of a conventional PWM drive circuit in which through rate control is performed is shown in FIG. 6. In FIG. 6, such circuit blocks as are found also in FIG. 5 are identified with the same reference numerals, and their explanations will not be repeated.

The PWM drive circuit shown in FIG. 6 differs from the PWM drive circuit shown in FIG. 5 in the following ways. The resistor R1 is removed and instead a circuit in which resistors R3 and R4 are connected in series is provided between the drain of the PMOS transistor Q1 and the drain of the NMOS transistor Q2, the gate of the PMOS transistor Q5 is connected to a node at which the resistors R3 and R4 are connected together, the resistor R2 is removed and instead a circuit in which resistors R5 and R6 are connected in series is provided between the drain of the PMOS transistor Q3 and the drain of the NMOS transistor Q4, and the gate of the NMOS transistor Q6 is connected to a node at which the resistors R5 and R6 are connected together.

As is the case with the PWM drive circuit shown in FIG. 5, the PWM drive circuit shown in FIG. 6 can reduce switching noise because a CR circuit built with the resistor R3 or R4 and a capacitance of the PMOS transistor Q5 (such as a gate-source capacitance or a gate-backgate capacitance) makes a gate voltage of the PMOS transistor Q5, which is a load driving power MOS transistor, rise or drop gradually and a CR circuit built with the resistor R5 or R6 and a capacitance of the NMOS transistor Q6 (such as a gate-source capacitance or a gate-backgate capacitance) makes a gate voltage of the NMOS transistor Q6, which is a load driving power MOS transistor, rise or drop gradually.
Patent Document 1: JP-A-2001-204187

### DISCLOSURE OF THE INVENTION

Problems to be Solved by the Invention

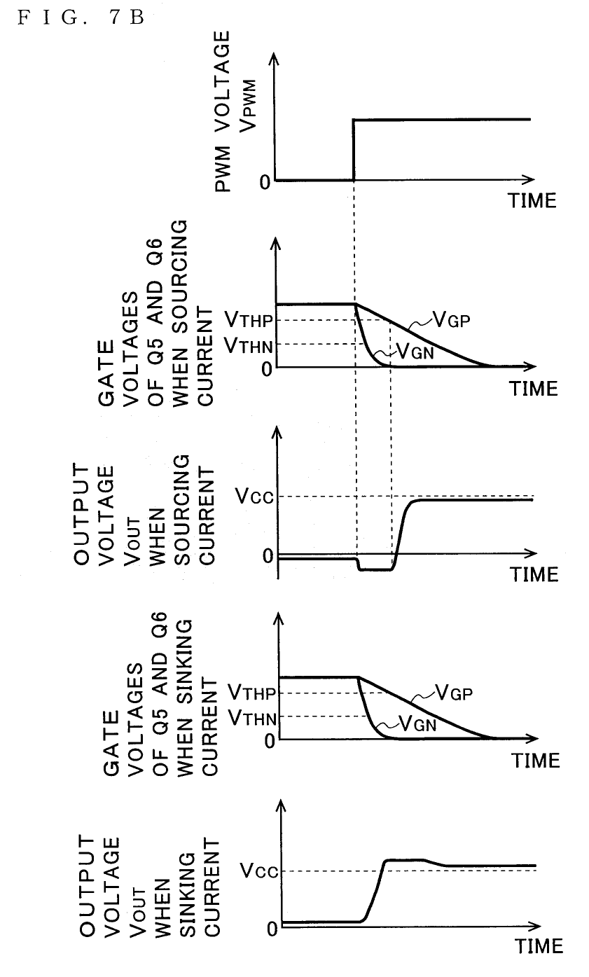

Here, FIG. 7A shows a time chart of a PWM voltage V_{PWM}, a gate voltage V_{GP} of the PMOS transistor Q5, a gate voltage V_{GN} of the NMOS transistor Q6, and an output voltage V_{OUT} as observed when the PWM voltage V_{PWM} is switched from a High level to a Low level in the conventional PWM drive circuit shown in FIG. 5 or 6. For the gate voltage V_{GP} of the PMOS transistor Q5, the gate voltage V_{GN} of the NMOS transistor Q6, and the output voltage V_{OUT}, waveforms thereof as observed when current flows from the output terminal 3 to a load (when sourcing current) and when current flows into the output terminal 3 (when sinking current) are shown.

The gate voltage V_{GN} of the NMOS transistor Q6 gradually rises with a time constant of the CR circuit from a point (t1) at which the PWM voltage V_{PWM} is inverted from a High level to a Low level. Then, at a point (t2) at which the gate voltage V_{GN} of the NMOS transistor Q6 reaches a threshold value V_{THN}, the NMOS transistor Q6 is switched from off to on.

Even after the NMOS transistor Q6 is switched from off to on, the gate voltage V_{GN} of the NMOS transistor Q6 continues to rise gradually with a time constant of the CR circuit until a point (t3) at which it reaches a predetermined value (which is nearly equal to V_{CC}). This makes it impossible for the NMOS transistor Q6 to obtain a sufficiently low on-resistance during the period between t2 and t3.

On the other hand, when the PWM voltage V_{PWM} is switched from a Low level to a High level, the PMOS transistor Q5 cannot obtain a sufficiently low on-resistance in a given period of time (see FIG. 7B).

With the conventional PWM drive circuit shown in FIG. 5 or 6, although switching noise is reduced by the through rate control, there arises a problem that switching loss is increased because the load driving power MOS transistor cannot obtain a sufficiently low on-resistance during the period from the point at which the load driving power MOS transistor is switched from off to on until the point at which the gate voltage thereof is completely inverted. This problem becomes much more pronounced when an output of the PWM drive circuit is fed to a load including an inductance component.

Patent Document 1 aims at reducing switching noise and switching loss by providing an oscillation circuit and a backflow prevention diode in a drive control device that drives a motor by performing PWM control thereof. However, with this configuration, there arises a new problem that, for example, a coil of the oscillation circuit hampers the miniaturization of the device.

In view of the conventionally experienced problems described above, it is an object of the present invention to provide a PWM drive circuit that suffers less from switching noise and switching loss.

Means for Solving the Problem

To achieve the above object, according to the present invention, a PWM drive circuit is provided with: a field-effect transistor for driving a load (hereinafter a “load driving field-effect transistor”); a through rate control portion for reducing a through rate of a voltage based on a PWM voltage and then feeding the resultant voltage to a gate of the load driving field-effect transistor; and a gate voltage control portion for stopping an operation of the through rate control portion and pulling up or down a gate potential of the load driving field-effect transistor to a predetermined value upon detecting during a transition period of a gate voltage of the load driving field-effect transistor that an output voltage of the load driving field-effect transistor has almost been inverted and become approximately equal to a value obtained when the load driving field-effect transistor is completely on.

With this configuration, the load driving field-effect transistor quickly transitions when, during a transition period of the gate voltage of the load driving field-effect transistor, the output voltage of the load driving field-effect transistor is almost inverted and becomes approximately equal to a value obtained when the load driving field-effect transistor is completely on. This makes it possible to shorten the period from the point at which the load driving field-effect transistor is switched from off to on until the point at which the gate voltage is completely inverted. This helps shorten the period during which the on-resistance of the load driving field-effect transistor is relatively high, and thus helps reduce switching loss. Furthermore, as is the case with the conventional example, when the load driving field-effect transistor is switched from on to off as a result of the inversion of the PWM voltage, the gate voltage of the load driving field-effect transistor gradually varies with a characteristic of the through rate control portion. This makes it possible to reduce switching noise.

Preferably, as a result of detection of the PWM voltage and the output voltage of the load driving field-effect transistor, only when a value of the PWM voltage is found to be at a level at which the load driving field-effect transistor is turned on and a value of the output voltage of the load driving field-effect transistor is found to be approximately equal to a value obtained when the load driving field-effect transistor is completely on, the gate voltage control portion may stop the operation of the through rate control portion and pull up or down the gate potential of the load driving field-effect transistor to the predetermined value.

With this configuration, it is possible to prevent the gate voltage control portion from unnecessarily stopping the operation of the through rate control portion and pulling up or down the gate potential of the load driving field-effect transistor to the predetermined value. This ensures accurate on/off switching of the load driving field-effect transistor according to the PWM voltage.

The PWM drive circuit according to the present invention can be applied to motor drive circuits, DC-DC converters, or the like.

Effect of the Invention

According to the present invention, it is possible to achieve a PWM drive circuit that suffers less from switching noise and switching loss.

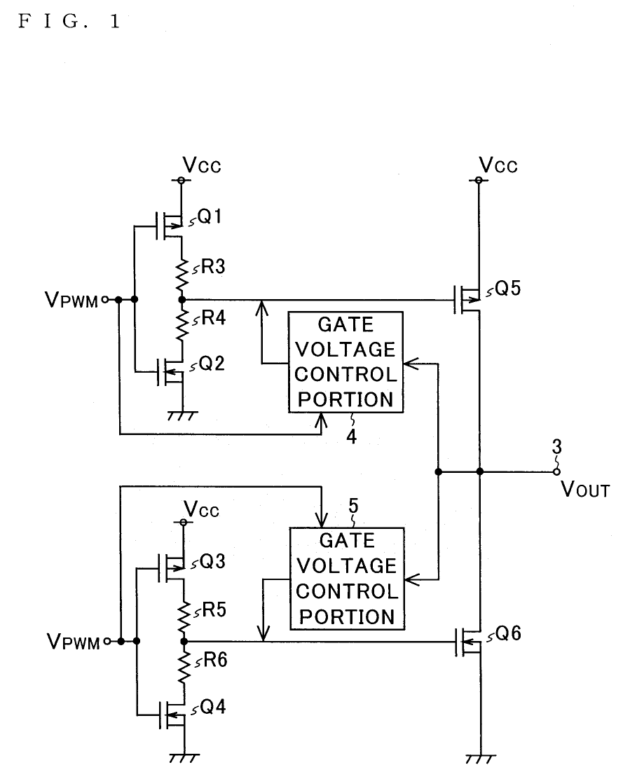

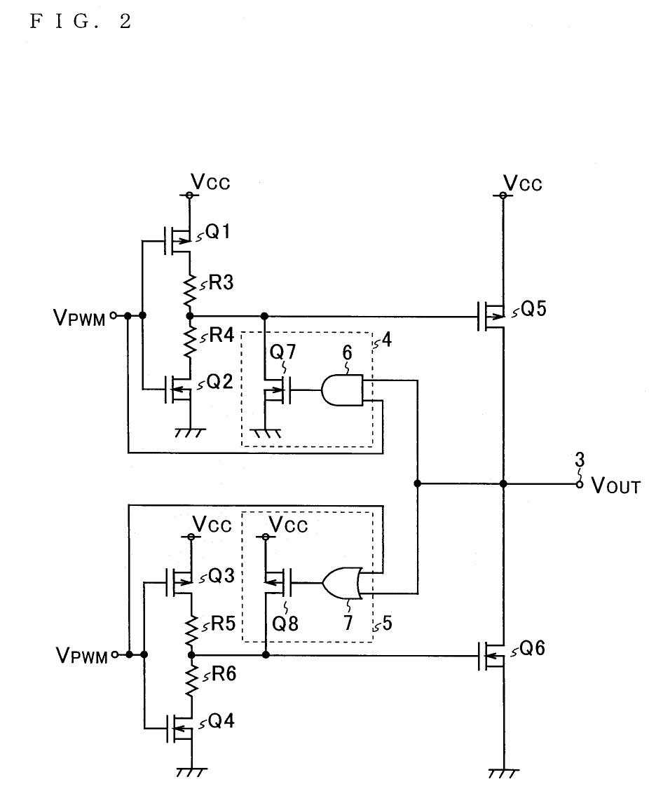

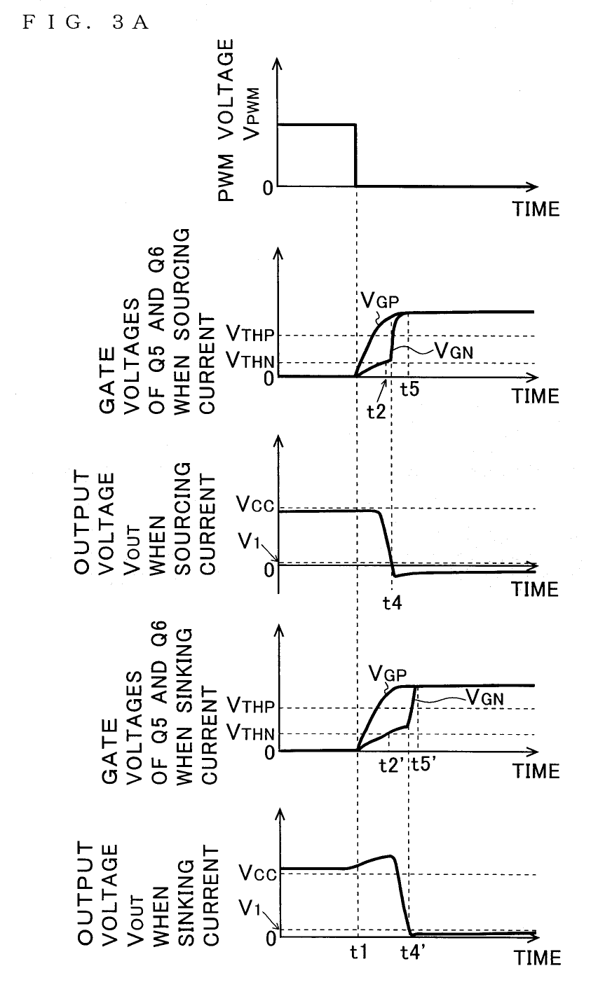

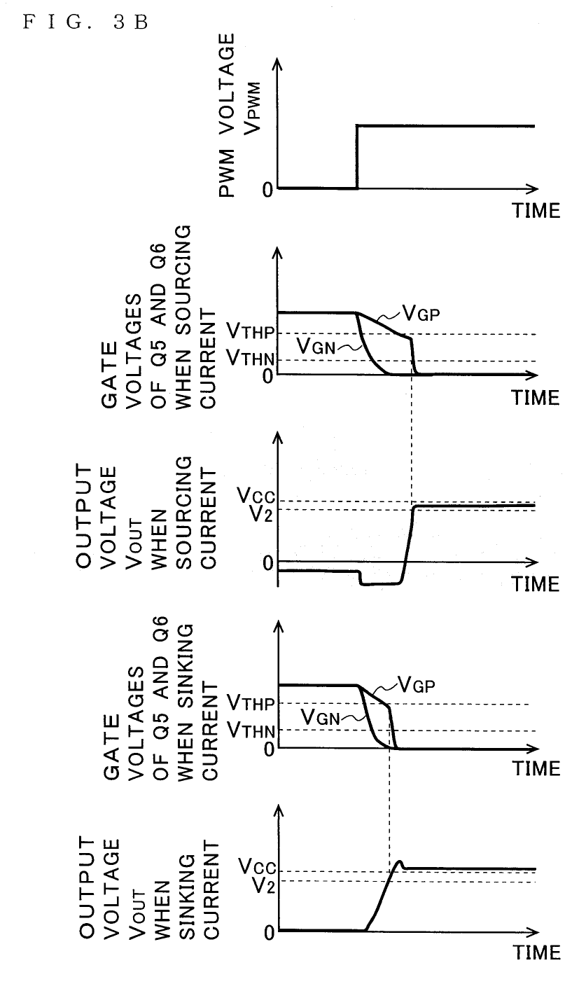

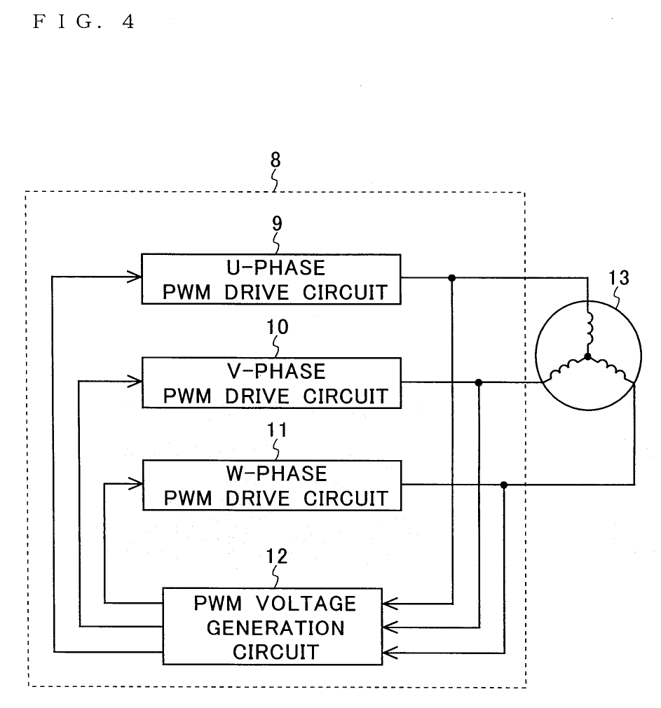

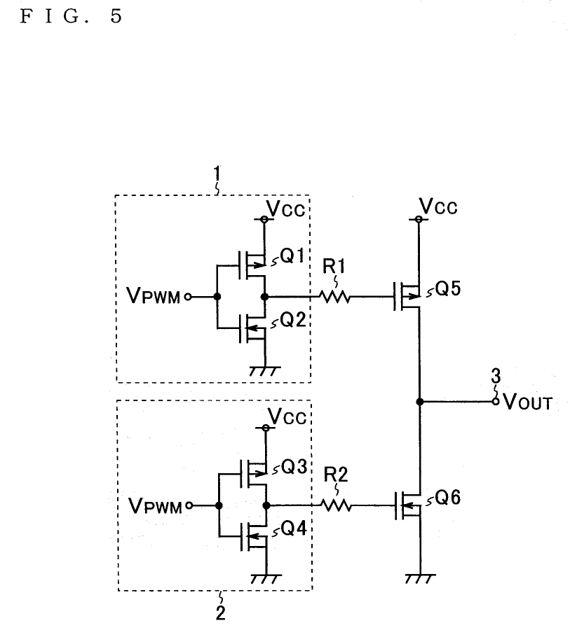

### BRIEF DESCRIPTION OF DRAWINGS

[FIG. 1] A diagram showing an example of the configuration of a PWM drive circuit according to the present invention.

[FIG. 2] A diagram showing an example of the circuit configuration of the PWM drive circuit shown in FIG. 1.

[FIG. 3A] A time chart of voltages of relevant circuit blocks of the PWM drive circuit shown in FIG. 2.

[FIG. 3B] A time chart of voltages of relevant circuit blocks of the PWM drive circuit shown in FIG. 2.

[FIG. 4] A block diagram showing an example of the configuration of a motor drive circuit according to the present invention.

[FIG. 5] A diagram showing an example of the configuration of a conventional PWM drive circuit.

[FIG. 6] A diagram showing another example of the configuration of a conventional PWM drive circuit.

[FIG. 7A] A time chart of voltages of relevant circuit blocks of the PWM drive circuit shown in FIG. 5 or 6.

[FIG. 7B] A time chart of voltages of relevant circuit blocks of the PWM drive circuit shown in FIG. 5 or 6.

### LIST OF REFERENCE SYMBOLS

1, 2 inverter circuit

3 output terminal

5 gate voltage control portion

6 AND gate

7 OR gate

8 motor drive circuit

9 U-phase PWM drive circuit

10 V-phase PWM drive circuit

11 W-phase PWM drive circuit

12 PWM voltage generation circuit

13 three-phase brushless motor

Q1, Q3, Q5, Q8 PMOS transistor

Q2, Q4, Q6, Q7 NMOS transistor

R1 to R6 resistor

### BEST MODE FOR CARRYING OUT THE INVENTION

Hereinafter, one embodiment of the present invention will be described with reference to the accompanying drawings. An example of the configuration of a PWM drive circuit according to the present invention is shown in FIG. 1. In FIG. 1, such circuit blocks as are found also in FIG. 6 are identified with the same reference numerals, and their explanations will not be repeated.

The PWM drive circuit of the present invention shown in FIG. 1 differs from a PWM drive circuit shown in FIG. 6 in that gate voltage control portions 4 and 5 are additionally provided. The gate voltage control portion 4 detects an output voltage V_{OUT} and a PWM voltage V_{PWM}. If the output voltage V_{OUT} is found to have been increased to a predetermined value (which is nearly equal to V_{CC}) and have almost been inverted and the PWM voltage V_{PWM} is found to be at a High level, the gate voltage control portion 4 pulls down the gate potential of the PMOS transistor Q5 to reduce the gate voltage of the PMOS transistor Q5 quickly, thereby shortening the time needed to completely invert the gate voltage of the PMOS transistor Q5.

The gate voltage control portion 5 detects an output voltage V_{OUT} and a PWM voltage V_{PWM}. If the output voltage V_{OUT} is found to have been reduced to a predetermined value (which is nearly equal to zero) and have almost been inverted and the PWM voltage V_{PWM} is found to be at a Low level, the gate voltage control portion 5 pulls up the gate potential of the NMOS transistor Q6 to increase the gate voltage of the NMOS transistor Q6 quickly, thereby shortening the time needed to completely invert the gate voltage of the NMOS transistor Q6.

Since the PWM drive circuit of the present invention shown in FIG. 1 is provided with the gate voltage control portions 4 and 5 that perform the operations described above, it is possible to shorten the period from the point at which the PMOS transistor Q5 or the NMOS transistor Q6, which is a load driving power MOS transistor, is switched from off to on until the point at which the gate voltage is completely inverted. This helps shorten the period during which the on-resistance of the load driving power MOS transistor is relatively high, making it possible to reduce switching loss. Moreover, as is the case with the conventional example, when the load driving power MOS transistor is switched from on to off as a result of the inversion of the PWM voltage V_{PWM}, the gate voltage of the load driving power MOS transistor gradually varies with a time constant of the CR circuit until the output voltage V_{OUT} is almost inverted. This helps reduce switching noise.

Instead, the gate voltage control circuit 4 can be made to detect only an output voltage V_{OUT} so that, if the output voltage V_{OUT} is found to have been increased to a predetermined value (which is nearly equal to V_{CC}) and have almost been inverted, the gate voltage control circuit 4 pulls down the gate potential of the PMOS transistor Q5, and the gate voltage control circuit 5 can be made to detect only an output voltage V_{OUT} so that, if the output voltage V_{OUT} is found to have been reduced to a predetermined value (which is nearly equal to zero) and have almost been inverted, the gate voltage control circuit 5 pulls up the gate potential of the NMOS transistor Q6. However, to prevent the gate potential of the load driving power MOS transistor from being pulled up or down more than necessary, it is preferable to adopt the configuration shown in FIG. 1. Alternatively, it is also possible to reduce switching noise and switching loss, as is the case with the PWM drive circuit shown in FIG. 1, by configuring the PWM drive circuit in the following ways. The resistors R3 and R4 are removed from the PWM drive circuit shown in FIG. 1 and instead a resistor is provided that is connected at one end thereof to a node at which the PMOS transistor Q1 and the NMOS transistor Q2 are connected together and is connected at the other end thereof to a node at which the gate of the PMOS transistor Q5 and the gate voltage control portion 4 are connected together, and the resistors R5 and R6 are removed and instead a resistor is provided that is connected at one end thereof to a node at which the PMOS transistor Q3 and the NMOS transistor Q4 are connected together and is connected at the other end thereof to a node at which the gate of the NMOS transistor Q6 and the gate voltage control portion 5 are connected together.

Next, an example of the circuit configuration of the PWM drive circuit shown in FIG. 1 is shown in FIG. 2. In FIG. 2, such circuit blocks as are found also in FIG. 1 are identified with the same reference numerals, and their explanations will not be repeated.

In the PWM drive circuit shown in FIG. 2, an AND gate 6 and an NMOS transistor Q7 together form the gate control portion 4, and an OR gate 7 and a PMOS transistor Q8 together form the gate control portion 5.

The drain of the NMOS transistor Q7 is connected to the gate of the PMOS transistor Q5, and the source of the NMOS transistor Q7 is grounded. The AND gate 6 takes the AND of the output voltage V_{OUT} and the PWM voltage V_{PWM}, and then feeds the result to the gate of the NMOS transistor Q7.

The drain of the PMOS transistor Q8 is connected to the gate of the NMOS transistor Q6, and a constant voltage V_{CC} is applied to the source of the PMOS transistor Q8. The OR gate 7 takes the OR of the output voltage V_{OUT} and the PWM voltage V_{PWM}, and then feeds the result to the gate of the PMOS transistor Q8.

Here, FIG. 3A shows a time chart of a PWM voltage V_{PWM}, a gate voltage V_{GP} of the PMOS transistor Q5, a gate voltage V_{GN} of the NMOS transistor Q6, and an output voltage V_{OUT} as observed when the PWM voltage V_{PWM} is switched from a High level to a Low level in the PWM drive circuit shown in FIG. 2. For the gate voltage V_{GP} of the PMOS transistor Q5, the gate voltage V_{GN} of the NMOS transistor Q6, and the output voltage V_{OUT}, waveforms thereof as observed when current flows from an output terminal 3 to a load (when sourcing current) and when current flows into the output terminal 3 (when sinking current) are shown.

The gate voltage V_{GN} of the NMOS transistor Q6 gradually rises with a time constant of a CR circuit from a point (t1) at which the PWM voltage V_{PWM} is inverted from a High level to a Low level. Then, at a point (t2 or t2′) at which the gate voltage V_{GN} of the NMOS transistor Q6 reaches a threshold value V_{THN}, the NMOS transistor Q6 is switched from off to on.

Even after the NMOS transistor Q6 is switched from off to on, the gate voltage V_{GN} of the NMOS transistor Q6 continues to rise gradually with a time constant of the CR circuit until a point (t4 or t4′) at which the output voltage V_{OUT} reaches a predetermined value V₁ (=Low level) and the PWM voltage V_{PWM} takes a Low level. At point t4 or t4′, the output of the OR gate 7 is switched from a High level to a Low level, and the PMOS transistor Q8 is switched from off to on. Thus, after point t4 or t4′, the gate voltage V_{GN} of the NMOS transistor Q6 is quickly increased up to a point (t5 or t5′) at which it reaches a predetermined value (which is nearly equal to V_{CC}). This makes a period (from point t2 to point t5 or from point t2′ to point T5′) during which the NMOS transistor Q6 cannot obtain a sufficiently low on-resistance in the PWM drive circuit of the present invention shown in FIG. 2 shorter than a period (point t2 to point t3 shown in FIG. 7) during which the NMOS transistor Q6 cannot obtain a sufficiently low on-resistance in the conventional PWM drive circuit shown in FIG. 5 or 6.

In addition, since the gate control portion 4 built with the AND gate 6 and the NMOS transistor Q7 is provided, a period during which the PMOS transistor Q5 cannot obtain a sufficiently low on-resistance is made shorter than that of the conventional example (see FIG. 3B).

This makes it possible to achieve a through rate equal to or lower than that of the conventional example and thereby reduce switching noise and switching loss.

Note that the aforementioned predetermined value V₁ can be set by adjusting the gate width/length of a MOS transistor provided in the AND gate 6. A similar setting (setting of a predetermined value V₂ shown in FIG. 3B) can be done for the OR gate 7 by adjusting the gate width/length of a MOS transistor provided in the OR gate 7.

The above-described PWM drive circuit of the present invention can be applied to DC-DC converters, motor drive circuits, or the like.

By connecting to the output terminal of the PWM drive circuit of the present invention a smoothing circuit (for instance, a circuit built with: an inductor connected at one end thereof to the output terminal; and a capacitor connected at one end thereof to the other end of the inductor and connected at the other end thereof to a ground potential), it is possible to achieve a DC-DC converter that suffers less from switching noise and switching loss.

Next, a case in which the PWM drive circuit of the present invention is applied to a motor drive circuit will be described. FIG. 4 shows an example of the configuration of a motor drive circuit provided with the PWM drive circuit of the present invention. A motor drive circuit 8 has a U-phase PWM drive circuit 9, a V-phase PWM drive circuit 10, a W-phase PWM drive circuit 11, and a PWM voltage generation circuit 12. Here, the U-phase PWM drive circuit 9, the V-phase PWM drive circuit 10, and the W-phase PWM drive circuit 11 have the same configuration as that of the PWM drive circuit shown in FIG. 2.

The output terminal of the U-phase PWM drive circuit 9 is connected to a U-phase stator coil of a three-phase brushless motor 13, the output terminal of the V-phase PWM drive circuit 10 is connected to a V-phase stator coil of the three-phase brushless motor 13, and the output terminal of the W-phase PWM drive circuit 11 is connected to a W-phase stator coil of the three-phase brushless motor 13. The PWM drive circuit 12 receives a motor voltage at each phase of the three-phase brushless motor 13, then generates a PWM voltage at each phase based on the received motor voltage, and then outputs the U-phase PWM voltage to the U-phase PWM drive circuit 9, the V-phase PWM voltage to the V-phase PWM drive circuit 10, and the W-phase PWM voltage to the W-phase PWM drive circuit 11.

With this configuration, it is possible to achieve a motor drive circuit that suffers less from switching noise and switching loss. Although the PWM drive circuit 12 provided in the motor drive circuit shown in FIG. 4 generates a PWM voltage at each phase based on a motor voltage at each phase, in a case where the motor drive circuit is connected to a three-phase brushless motor having a rotor position detecting sensor, the PWM drive circuit 12 may be replaced by a PWM drive circuit that receives an output signal of the rotor position detecting sensor and generates a PWM voltage at each phase based on the output signal of the rotor position detecting sensor.

### INDUSTRIAL APPLICABILITY

The PWM drive circuit of the present invention can be applied to motor drive circuits, DC-DC converters, or the like. The motor drive circuit can be applied to electric apparatuses having a motor in general, and the DC-DC converter can be used as a direct-current power supply provided in an electric apparatus.

1. A PWM drive circuit comprising:
a load driving field-effect transistor;
a through rate control portion for reducing a through rate of a voltage based on a PWM voltage and then feeding the resultant voltage to a gate of the load driving field-effect transistor; and
a gate voltage control portion for stopping an operation of the through rate control portion and pulling up or down a gate potential of the load driving field-effect transistor to a predetermined value upon detecting during a transition period of a gate voltage of the load driving field-effect transistor that an output voltage of the load driving field-effect transistor has almost been inverted and become approximately equal to a value obtained when the load driving field-effect transistor is completely on.

2. The PWM drive circuit of claim 1, wherein
as a result of detection of the PWM voltage and the output voltage of the load driving field-effect transistor, only when a value of the PWM voltage is found to be at a level at which the load driving field-effect transistor is turned on and a value of the output voltage of the load driving field-effect transistor is found to be approximately equal to a value obtained when the load driving field-effect transistor is completely on, the gate voltage control portion stops the operation of the through rate control portion and pulls up or down the gate potential of the load driving field-effect transistor to the predetermined value.

3. A motor drive circuit comprising:
a PWM voltage generation circuit for generating a PWM voltage; and
a PWM drive circuit for driving a motor based on the PWM voltage outputted from the PWM voltage generation circuit, wherein
the PWM drive circuit includes
a load driving field-effect transistor,
a through rate control portion for reducing a through rate of a voltage based on the PWM voltage and then feeding the resultant voltage to a gate of the load driving field-effect transistor, and
a gate voltage control portion for stopping an operation of the through rate control portion and pulling up or down a gate potential of the load driving field-effect transistor to a predetermined value upon detecting during a transition period of a gate voltage of the load driving field-effect transistor that an output voltage of the load driving field-effect transistor has almost been inverted and become approximately equal to a value obtained when the load driving field-effect transistor is completely on.

4. The motor drive circuit of claim 3, wherein
as a result of detection of the PWM voltage and the output voltage of the load driving field-effect transistor, only when a value of the PWM voltage is found to be at a level at which the load driving field-effect transistor is turned on and the output voltage of the load driving field-effect transistor is found to be approximately equal to a value obtained when the load driving field-effect transistor is completely on, the gate voltage control portion stops the operation of the through rate control portion and pulls up or down the gate potential of the load driving field-effect transistor to the predetermined value.

5. The motor drive circuit of claim 3, wherein
the PWM voltage generation circuit generates the PWM voltage according to a rotor position of the motor.

6. The motor drive circuit of claim 4, wherein
the PWM voltage generation circuit generates the PWM voltage according to a rotor position of the motor.

7. A DC-DC converter comprising a PWM drive circuit, wherein
the PWM drive circuit includes
a load driving field-effect transistor,
a through rate control portion for reducing a through rate of a voltage based on a PWM voltage and then feeding the resultant voltage to a gate of the load driving field-effect transistor, and
a gate voltage control portion for stopping an operation of the through rate control portion and pulling up or down a gate potential of the load driving field-effect transistor to a predetermined value upon detecting during a transition period of a gate voltage of the load driving field-effect transistor that an output voltage of the load driving field-effect transistor has almost been inverted and become approximately equal to a value obtained when the load driving field-effect transistor is completely on.

8. The DC-DC converter of claim 7, wherein
as a result of detection of the PWM voltage and the output voltage of the load driving field-effect transistor, only when a value of the PWM voltage is found to be at a level at which the load driving field-effect transistor is turned on and a value of the output voltage of the load driving field-effect transistor is found to be approximately equal to a value obtained when the load driving field-effect transistor is completely on, the gate voltage control portion stops the operation of the through rate control portion and pulls up or down the gate potential of the load driving field-effect transistor to the predetermined value.
